(19) United States
(12) Patent Application Publication
(10) Pub. No.: US 2015/0326847 A1
(43) Pub. Date: Nov. 12, 2015

(54) METHOD AND SYSTEM FOR CAPTURING A 3D IMAGE USING SINGLE CAMERA

(71) Applicant: THOMSON LICENSING, lssy-les-Moulineaux (FR)

(72) Inventors: Wei ZHOU, Beijing (CN); Lin DU, Beijing (CN)

(21) Appl. No.: 14/648,706

(22) PCT Filed: Nov. 30, 2012
(86) PCT No.: PCT/CN2012/085613

§ 371 Date: May 30, 2015

(51) Int. Cl. H04N 13/02

(52) U.S. Cl. CPC H04N 13/0221; H04N 13/0296; H04N 13/0271

(57) ABSTRACT

A method, which is used to create a 3D image using a single camera, comprises capturing a first image by a single camera as either right or left side image in a first position; extracting feature points of the first image; shooting a picture to find a second image as the other side image in a position that is different from the first position; extracting feature points of the picture; comparing the feature points of the first image and the picture; generating two 3D cursors wherein one of which denotes the target position of the second image, and the other denotes the current position of the camera; displaying the two 3D cursors in the picture; capturing the second image when the cursor denoting the current position completely overlap to the cursor denoting the target position by translating and rotating the camera; and combining the first and second images to create a 3D image.

### FIELD OF THE INVENTION

The present invention relates to a method and system for capturing a 3D image using single camera. More particularly, the present invention relates to a method and system for capturing a 3D image using single camera by utilizing 3D cursors.

### BACKGROUND OF THE INVENTION

The basic idea of 3D stereo appeared in 19th century. Because our two eyes are approximately 6.5 cm apart in our head, each eye sees a scene we are viewing at a slightly different angle of view, and this provides different perspectives. Our brain can then create the feeling of depth within the scene based on the two views from our eyes. FIG. 1 illustrated the basic concept of the 3D stereoscopic displays, where Z is the depth of a perceived object and D is the distance to the screen, four objects are perceived as being in front of the screen (the car), on the screen (the column), behind the screen (the tree), and at an infinite distance (the box). Most modern 3D displays are built based on the 3D stereo concepts, with the major difference being the manner by which the two views, i.e., to left and right eyes respectively, are separated.

Based on this principle, there are many methods for taking stereo photograph. Presently, the most popular methods are using the same two cameras and using a stereo camera.

FIG. 2 illustrated the basic method of using 2 cameras to capture a stereo photograph. Two cameras are placed by being separated by a certain distance. Two photographs are taken by the two cameras at the same time. Then, after developing, you see the photo taken by left camera with your left eye and the photo taken by right camera with your right eye. And your brain will image real the 3D space where you took the photograph.

A stereo camera is a type of camera with two or more lenses with a separate image sensor or film frame for each lens. This allows the camera to simulate human binocular vision, and therefore provides the ability to capture three-dimensional images, a process known as stereo photography. Stereo cameras may be used for making stereo views and 3D pictures for movies. The distance between the lenses in a stereo camera (the intra-axial distance) is defined according to how much 3-dimensionality is desired and how far the target is located.

Both of the methods need two lenses, and the users should be professional photographers. And due to the hardware limits on a mobile device, ordinary users who have a mobile device with a single camera capture a 3D photograph with difficulty. If the mobile device users want to take a stereo 3D photo, they need to take two photos of the same object. Firstly, a photo of the object is taken. Then the camera is moved a little to the right or left, and the second photo is taken. In the remainder of this disclosure, it is assumed that the first photo is for left eye and the second for right eye. Finally, the two pictures are combined into a stereo 3D image by computing. But the users will spend a lot of time and energy in post production, and sometime the effect of the 3D photo is insufficient. Because they take the two photos too subjectively, the left and right image will rarely match, and will not achieve the 3D effect. This disclosure will propose a method of capture a stereo 3D image using a single camera for a mobile device. The system will help the cameramen to take the left image and the right image accurately in order to simplify post production, and obtain a better effect for a 3D picture. Creating the illusion of 3 dimensions relies entirely on the fact that we have two eyes separated by a particular distance. If each eye is shown the same image shot from a slightly different angle then when our brain combines the images, the combined image will appear three dimensional.

According to this principle, this invention is provided a method for the capture of stereo 3D images using a single camera. The camera will capture the left image and the right image respectively. After the camera captures the left image, the system will give some prompts about the right image's best position to the users. The users can accurately capture the right image for combining to make a stereo image according to the prompts. Therefore, this invention is aimed to solve the problem of how to give some prompts about the right image's position for being combined into a stereo 3D image.

As related art, US20100316282 discloses a method for creating a 3D image on the basis of first and second pictures and information on the changes of location/direction between the first and second pictures.

### SUMMARY OF THE INVENTION

This invention discloses a method to capture a 3D image using a single camera. An image processing function is added to a mobile device with a single camera to the match feature points of left image and right pictures for capturing stereoscopic image.

When the mobile device captures the left image, the system will extract the feature points of the left image. And then when the mobile device has been moved to shoot the right picture, the system extracts the feature points of the right picture. It should be noted that, hereinafter, the right picture specifies a picture a camera is displaying in a display; on the other hand, a right image specifies an image taken by a camera to be combined into a stereo 3D image. Moreover, “capture” is used when taking a photo and “shoot” is used when displaying a picture.

Afterwards, the system uses a feature points matching method based on bidirectional maximal correlation and parallactic restriction to compare the feature points map of the left image with the feature points map of the right picture for analyzing object size. If the object size in two maps is the same, this suggests the viewing distance for both is the same. If the object size in two maps is different, the camera should be moved until the object size in the two maps is the same. Furthermore, the system compares the vertical disparity between both feature points maps. In addition, the camera should be translated and rotated to cancel vertical disparity. Finally, the users will be able to capture the right image for accurate combining into a stereo 3D image.

According to an aspect of the present invention, there is provided a method for creating a 3D image using a single camera, comprising the steps of: capturing a first image by a single camera as either right or left side image in a first position; extracting feature points of the first image; shooting a picture to find a second image as the other side image in a position that is different from the first position; extracting feature points of the picture; comparing feature points of the first image and the picture; generating two 3D cursors wherein one of which denotes the target position of the second image, and the other denotes the current position of the camera; displaying the two 3D cursors in the picture; capturing the second image when the cursor denoting the current position completely overlap to the cursor denoting the target position by translating and rotating the camera; and combining the first and second images to create a 3D image.

According to another aspect of the present invention, there is provided a system for creating a 3D image using a single camera, comprising: means for capturing a first image by a single camera as either right or left side image in a first position; means for extracting feature points of the first image; means for shooting a picture to find a second image as the other side image in a position that is different from the first position; means for extracting feature points of the picture; means for comparing feature points of the first image and the picture; means for generating two 3D cursors wherein one of which denotes the target position of the second image, and the other denotes the current position of the camera; means for displaying the two 3D cursors in the picture; means for capturing the second image when the cursor denoting the current position completely overlap to the cursor denoting the target position by translating and rotating the camera; and means for combining the first and second images to create a 3D image.

### BRIEF DESCRIPTION OF DRAWINGS

These and other aspects, features and advantages of the present invention will become apparent from the following description in connection with the accompanying drawings in which:

FIG. 1 is an exemplary diagram illustrating a concept of 3D stereoscopic displays;

FIG. 2 is an exemplary diagram illustrating the basic method of using 2 cameras to capture a stereo photograph;

FIGS. 3A to 3E show an exemplary flow chart illustrating the steps for capturing two images using a single camera according to an embodiment of the present invention.

FIGS. 4A and 4B show an exemplary flow chart illustrating the main steps of the 3D image capture system for a mobile phone according to an embodiment of the present invention.

FIG. 5 is an exemplary flow chart illustrating an exemplary block diagram of a system according to an embodiment of the present invention.

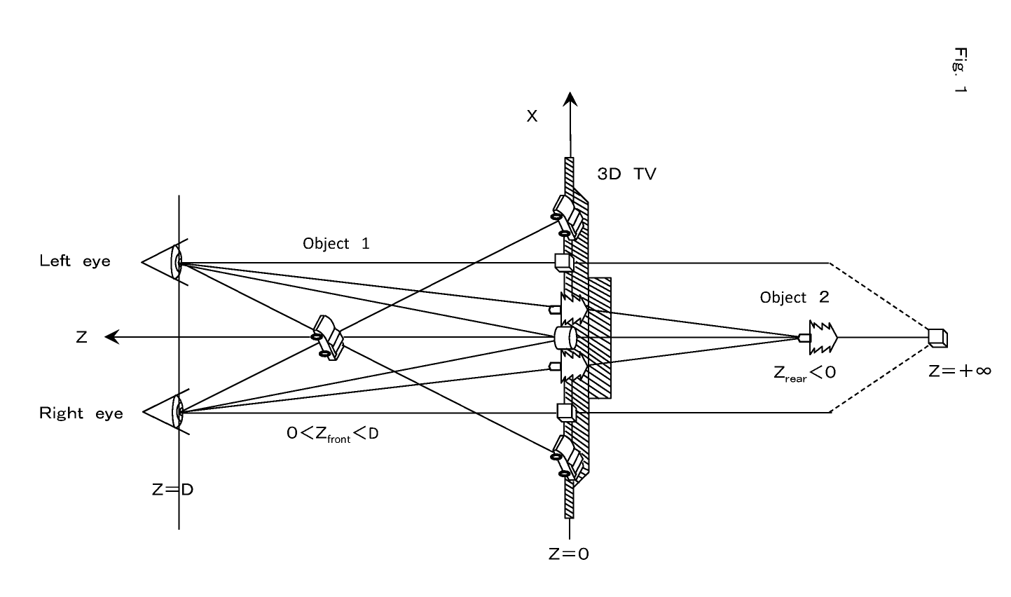

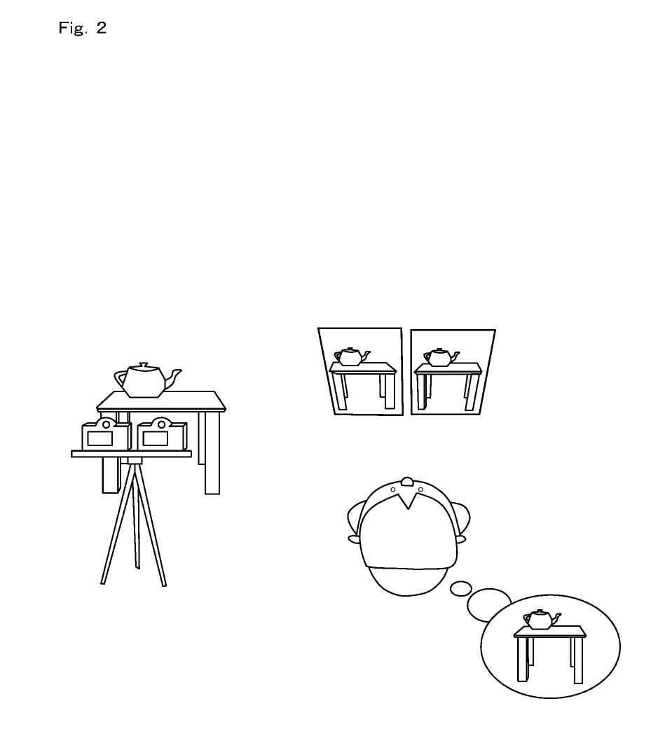

### DETAILED DESCRIPTION OF PREFERRED EMBODIMENTS

In the following description, various aspects of an embodiment of the present invention will be described. For the purpose of explanation, specific configurations and details are set forth in order to provide a thorough understanding. However, it will also be apparent to one skilled in the art that the present invention may be implemented without the specific details present herein.

This invention focuses on prompts of the second image capturing for combining a stereo 3D image when users use a single camera. It generally relates to a 3D image capture system that uses feature points matching method of to obtain position disparity data between the two images and parallax data.

When the mobile device captures the left image, the system will extract the feature points of the left image such that the feature points of the right image for a stereo 3D image are deduced. In addition, the system will give some prompts about the right image's best position to the users. Users can accurately capture the right image for combining into a stereo image according to the position data. When the user captures the right picture, there are two 3D cursors in the screen. One denotes the target position of the right image; the other denotes the current position of camera. When the two 3D cursors overlap, the user will capture the right image accurately for combining into a stereo 3D image.

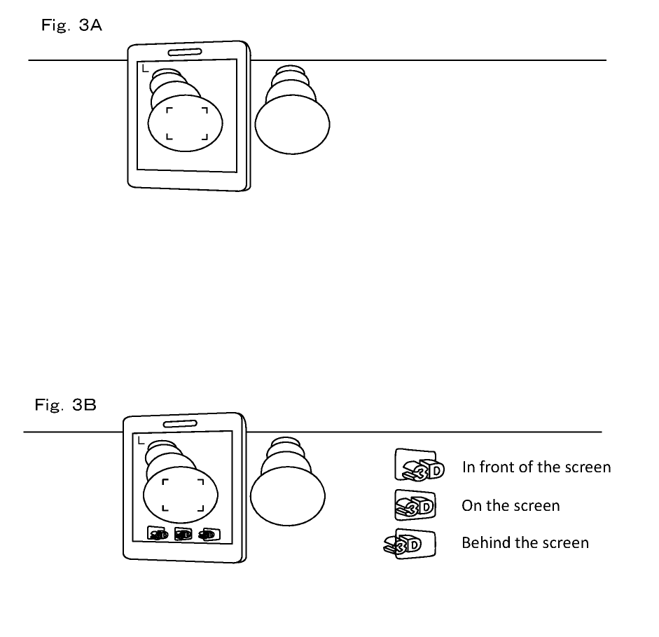

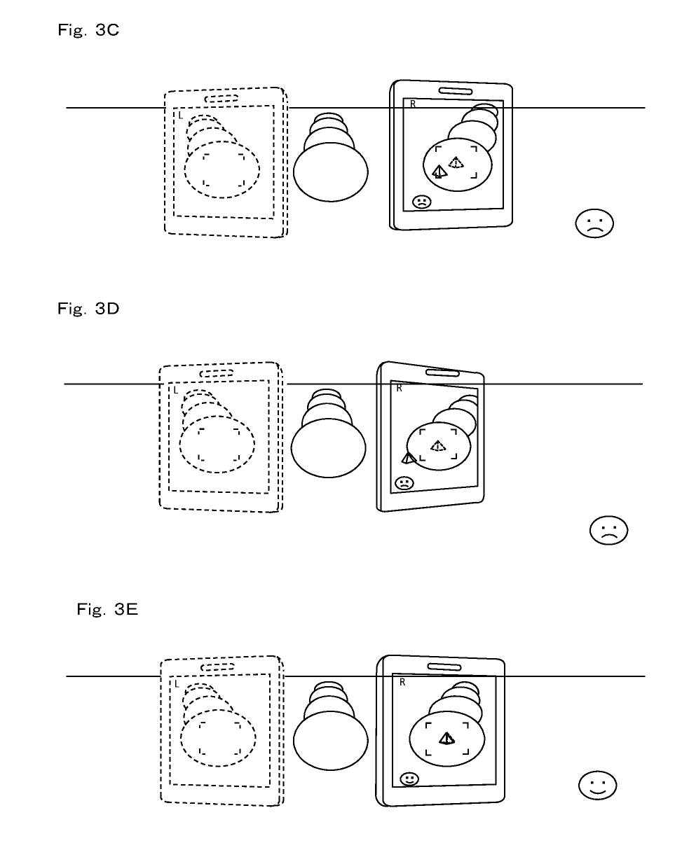

The steps for capturing two images using a mobile phone with a camera are shown as follows in accordance with FIGS. 3A to 3E

1. The user uses the mobile phone with a camera to capture the first image (FIG. 3A).

2. Three depth info icons are displayed in the screen. Three icons indicating “in front of the screen”, “on the screen”, and “behind the screen”. The user chooses one of the three icons on the basis of what effect on the parallax of two images the user desires (FIG. 3B).

3. The user moves the mobile phone to the right to find a view of the right image (FIG. 3C).

4. Two 3D cursors are displayed in the screen. One denotes the target position of the right image to capture and the other denotes the current position of camera. The user makes the two 3D cursors overlap through translation and rotation (FIG. 3D).

5. When the two 3D cursors overlap, the right image is captured (FIG. 3E).

One of the system descriptions is as follows, which is going to drive the 3D cursors.

1. The mobile device captures the left image.

2. The system will take the left image as the first image, and extract the feature points of the first image.

3. Three depth info icons are displayed in the screen.

Three icons indicate “in front of the screen”, “on the screen”, and “behind the screen”. A user chooses one of the three icons on the basis of what effect on the parallax of two images the user desires.

4. The mobile phone is moved to the right to find a view of the right image.

5. The system will extract the feature points of the right picture displaying in the display.

6. As is known, most modern 3D displays are built based on the 3D stereo concepts, with the major difference being how to separate the two views to left and right eyes respectively. Thus, the system will analyze the parallax between two pictures using a feature points matching method.

7. Two 3D cursors are displayed in the screen for adjusting the parallax between two pictures.

8. The system compares the feature point map, i.e. aggregate of feature points indicating outer boundary of an object, for the left image with the feature point map for the right picture using a feature points matching method on the basis of bidirectional maximal correlation and parallactic restriction, and thereby the system may analyze object sizes in both maps. If the object sizes in two maps are the same, this suggests the viewing distance for both picture is the same.

9. Two 3D cursors are displayed in the screen. If the size of each of the two 3D cursors is different, user should move the camera forwards or backwards until the sizes of both cursors become the same. Thereby, the viewing distance for both left image and right picture will be the same.

10. The system compares the vertical disparity between both feature point maps.

11. Two 3D cursors are displayed in the screen for canceling vertical disparity through translation and rotation.

12. Once the two 3D cursors overlap, the right image is captured. The system takes the right image as the second image. Then the system will combine the first and second images into a 3D stereo image accurately.

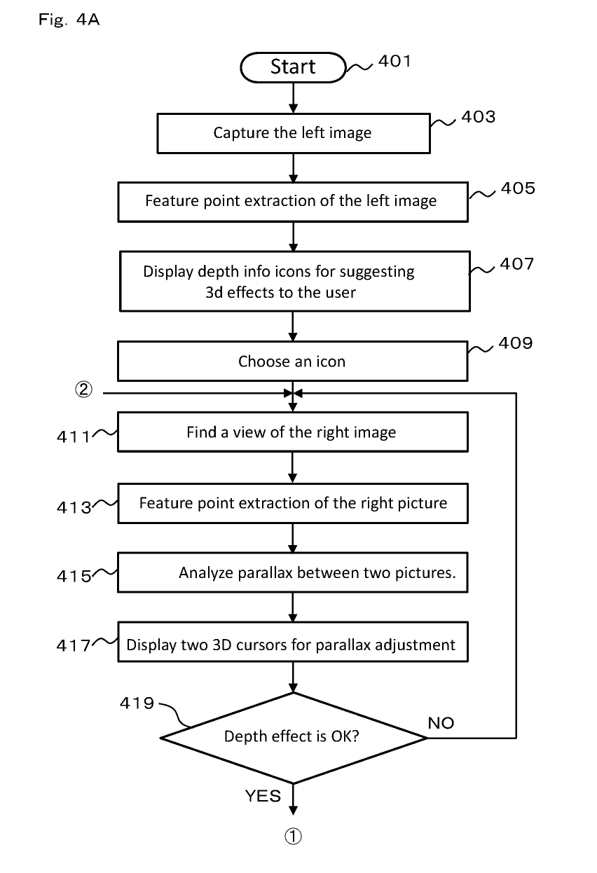

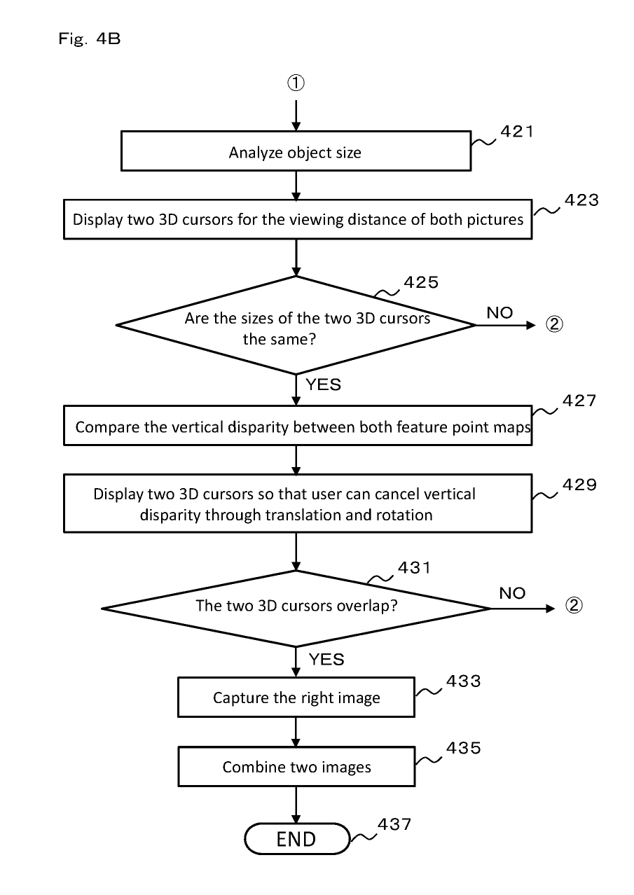

A flowchart illustrating the main steps of the 3D image capture system in a mobile phone is shown in FIGS. 4A and 4B. Start at step 401. The user captures the left image by a single camera at step 403. The 3D image capture system extracts feature points of the left image at step 405. The 3D image capture system displays three depth info icons in the screen for suggesting 3D effects to the user at step 407. The three icons indicate “in front of the screen”, “on the screen”, and “behind the screen”. The user chooses one of the three icons to attain the desired 3D effect at step 409. The user moves the camera to find a view of the right image at step 411. The 3D image capture system extracts feature points of a right picture being displayed in the display at step 413. The 3D image capture system analyzes the parallax between the left image and the right picture by comparing their feature point maps at step 415. The 3D image capture system displays two 3D cursors for parallax adjustment in the display at step 417. One of them denotes the target position of the right image; the other denotes the current position of camera. If the depth effect is satisfactory at step 419, then the process proceeds to step 421. If the depth effect is not satisfactory at step 419, then the process returns to step 411. The 3D image system analyzes the object sizes in both of the left image and the right picture using feature point map at step 421. The 3D image system displays the 3D cursors in the screen for the viewing distance of both of the left image and the right picture at step 423. If the sizes of the two 3D cursors are the same at step 425, then the process proceeds to step 427. If the sizes of the two 3D cursors are not the same at step 425, then the process returns to step 411. The 3D image system compares the vertical disparity between both of the left image and the right picture using feature point map at step 427. The 3D image system displays two 3D cursors so that the user can cancel the vertical disparity through translation and rotation of the camera at step 429. If the two 3D cursors overlap at step 431, then the process proceeds to step 433. If the two 3D cursors do not overlap at step 431, then the process returns to step 411. The user captures the right image at the position where the two cursors overlaps at step 433. The 3D image system combines the left and right images to create a 3D image at step 435. Then the process proceeds to end at step 427.

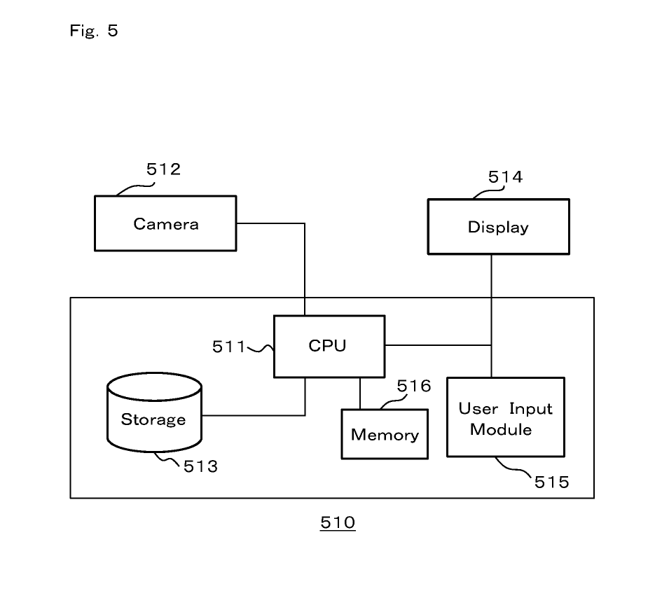

FIG. 5 illustrates an exemplary block diagram of a system 510 according to an embodiment of the present invention. The system 510 can be a mobile phone, computer system, tablet, portable game, smart-phone, and the like. The system 510 comprises a CPU (Central Processing Unit) 511, a camera 512, a storage 513, a display 514, and a user input module 515. A memory 516 such as RAM (Random Access Memory) may be connected to the CPU 511 as shown in FIG. 5.

The camera 512 is an element for capturing the left and right images with single lens. The CPU 511 processes the steps of the 3D image capture system as explained above.

The display 514 is configured to visually present text, image, video and any other contents to a user of the system 510. The display 514 can apply any type that is compatible with 3D contents.

The storage 513 is configured to store software programs and data for the CPU 511 to drive and operate the process to create a 3D image as explained above.

The user input module 515 may include keys or buttons to input characters or commands and also comprises a function for recognizing the characters or commands input with the keys or buttons. The user input module 515 can be omitted in the system depending on use application of the system.

This invention can be applied to mobile devices with a camera, such as a mobile phone, tablet and so on. It can take not only stereo but also multiview photos with similar hardware and software configurations, as multiview photos are essentially a series of adjacent stereo photos.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and inputoutput (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1-10. (canceled)

11. A method for capturing a second image to create a 3D image, comprising the steps of:
capturing a first image by a camera as either right or left side image in a first position;
extracting feature points of the first image;
extracting feature points of a picture which is being shot by a user to find a second image as the other side image in a position that is different from the first position;
generating and displaying two 3D cursors in the picture by comparing feature points of the first image and the picture, wherein one of which denotes the target position of the second image, and the other denotes the current position of the camera; and
capturing the second image when the cursor denoting the current position completely overlap to the cursor denoting the target position by translating and rotating the camera.

12. The method according to claim 11, wherein the 3D cursors are generated by analyzing size of an object and vertical disparity in feature point maps of the first image and the picture, the feature point map indicating feature points which are in outer circumference of the object in each of the first image and the picture.

13. The method according to claim 12, further comprising:
displaying three depth info icons to attain a desired effect on the parallax of the first and second images, the three depth icons indicating “in front of the screen”, “on the screen”, and “behind the screen,” respectively,
wherein the position of the target 3D cursor is determined to attain 3D effect of chosen depth icon.

14. The method according to claim 11, wherein if the sizes of the two 3D cursors are the same, viewing distances for the first position and the position are the same, the sizes of the two 3D cursors become the same by moving the camera forwards or backward.

15. The method according to claim 11, wherein the vertical disparity between the first image and the picture is canceled by translating and rotating the camera.

16. A device for capturing a second image to create a 3D image, comprising:
a camera with a display for capturing a first image in a first position and a second image in a second position as either right or left side image; and
a processor configured to implement:
extracting feature points of the first image and of a picture which is being shot by a user to find the second image as the other side image in a position that is different from the first position;
generating and displaying two 3D cursors in the picture by comparing feature points of the first image and the picture, wherein one of which denotes the target position of the second image, and the other denotes the current position of the camera;
wherein the second image is captured when the cursor denoting the current position completely overlap to the cursor denoting the target position by translating and rotating the camera.

17. The device according to claim 16, wherein the 3D cursors are generated by comparing includes means for analyzing size of an object and vertical disparity in feature point maps of the first image and the picture, the feature point map being indicated feature points which are in outer circumference of the object in each of the first image and the picture.

18. The device according to claim 17, wherein three depth info icons is displayed in the display to attain a desired effect on the parallax of the first and second images, the three depth icons indicating “in front of the screen”, “on the screen”, and “behind the screen,” respectively,
wherein the position of the target 3D cursor is determined to attain 3D effect of chosen depth icon.

19. The device according to claim 16, wherein if the sizes of the two 3D cursors are the same, viewing distances for the first position and the position are the same, the sizes of the two 3D cursors become the same by moving the camera forwards or backward.

20. The device according to claim 16, wherein the vertical disparity between the first image and the picture is canceled by translating and rotating the camera.
